(19) United States
(12) Patent Application Publication
(10) Pub. No.: US 2012/0151715 A1
(43) Pub. Date: Jun. 21, 2012

(54) Gate adjustment system

(76) Inventor: Richard P. Kuivila, Lone Tree, CO (US)

(21) Appl. No.: 13/374,193

(22) Filed: Dec. 15, 2011

Related U.S. Application Data
(60) Provisional application No. 61/459,588, filed on Dec. 15, 2010.

(51) Int. Cl. E05F 7/00

(52) U.S. Cl. 16/193

(57) ABSTRACT

A gate adjustment system has a bull-nose glide, a flat glide, a plurality of spacers, a gap size gauge, and a gap adjustment wedge. The glides are attached to the latch post and the latch side of a gate opposite one another. As the gate is shut, the bull-nose portion of the bull-nose glide impacts the rounded edge of the flat glide. The two curved surfaces allow the impact force to cause the gate to be lifted and pushed back into alignment. The gap adjustment wedge can be positioned between the top of the latch side and the latch post and pushed downwards into the gap until the gap is uniform from the top to the bottom. The gap size gauge then measures the size of the gap and that measurement is used to determine which of the plurality of spacers should be installed with the glides.

### CROSS-REFERENCE TO RELATED APPLICATIONS

The application claims benefit of U.S. Provisional Application No. 61/459,588 entitled “Gate Adjustment System” and filed on Dec. 15, 2010, which is specifically incorporated by reference herein for all that it teaches and discloses.

### TECHNICAL FIELD

The invention relates generally to fencing, gates, and gate hardware, and more particularly to a system for adjusting gates.

### BACKGROUND

There are many known types of gates. They vary across a wide spectrum of forms, shapes, sizes, etc. Nevertheless, a standard gate will generally be rectangular in shape and have two primary vertical components (a hinge side and a latch side) and two primary horizontal components (an upper edge and a lower edge). The hinge side is usually attached by one or more hinges to a fence, building, vertical post, etc. (hereafter, a “hinge post”). The hinges allow the gate to swing in an arc relative to the hinge post, usually through approximately ninety degrees of travel (although often up to one hundred and eighty degrees or more).

Opposite the hinge side is the latch side of the gate. As its name implies, the latch side usually has some type of latch attached thereto that allows the gate to be secured in a closed position. The latch side of a standard gate closes against or in proximity to an upright post or similar vertical surface (hereafter, a “latch post”). When properly installed, a uniform gap is left between the latch side of the gate and the upright latch post so that the gate can open and close easily without some portion of the latch side rubbing or catching on some portion of the latch post. This gap is called a latch post gap.

Running horizontally between the hinge side and the latch side (and generally perpendicular thereto) are the upper and lowers edges of the gate. These components form the main structure of the gate and determine the overall length of the gate. Together, the two edges and two sides form the rectangular shape that defines most standard gates. Such gates can be commonly found, for example, on fences surrounding residential properties. Of course, there are many other shapes and forms for gates and the present invention is applicable to many more types than just a standard gate.

Regardless of the particular type of gate, there is one more or less ubiquitous problem that any given gate will, almost invariably, suffer eventually: gate sag. Gate sag usually occurs because of the force of gravity acting on the gate. As gravity slowly pulls down the latch side, the hinge side usually stays generally in place because it is attached to a supporting structure by the hinges. Thus, the rectangle that previously defined the shape of the gate becomes deformed as the angles between the sides and the edges are forced out of ninety degrees. As the latch side continues to be drawn downwards by gravity, the latch post gap narrows and one portion (usually the upper end) of the latch side begins to contact the latch post. Over time, the contact can be become quite extreme, such that the gate is difficult to open and almost impossible to close, as the latch side no longer fits inside the latch post.

A number of devices are known in the art that attempt to address this problem. One common device uses a support wire that extends from the top of the hinge post across to the latch side of the gate. The support wire is under tension such that the latch side is supported and should not sag, in theory, under the affects of gravity. However, not only does the support wire often fail to completely forestall gate sag, it also disrupts the aesthetic appearance and look of the gate. Additionally, it can be extremely difficult to retro-fit an existing gate with a support wire once the gate begins to sag. Another device known in the art uses an adjustable tension gate bracket (see U.S. Pat. No. 6,751,906 to Bass). This device suffers from similar deficiencies as the support wire mentioned above. Other external support structures, such as the chain device disclosed by Harris in U.S. Pat. No. 4,468,888, are also known but suffer similar problems.

Thus, there remains a need for a gate adjustment system that can prevent, correct, or otherwise mitigate gate sag and can reduce the force or effort necessary to close a gate which has already sagged.

### SUMMARY

One embodiment of the present invention is a gate adjustment system comprising a bull-nose glide, a flat glide, a plurality of spacers, a gap size gauge, and a gap adjustment wedge. The two glides are attached to the latch post and the latch side of the gate opposite one another. Either glide can be attached to either location, but it is preferable to attach the bull-nose glide to the latch side of the gate. A preferred attachment location is near the top of the latch side, preferably above the latch itself. The glides are positioned so that as the gate is shut, the bull-nose portion of the bull-nose glide impacts the rounded edge of the flat glide. The two curved surfaces allow the impact force to be spread out and cause the gate to be lifted and pushed back towards the hinge side and into alignment.

The gap adjustment wedge is used during the initial installation procedure. With the gate closed, the gap adjustment wedge is positioned between the top of the latch side and the latch post—the gate can be lifted and the gap adjustment wedge pushed deeper into the gate gap until the gap is uniform from the top to the bottom. Once a uniform gap measurement is achieved, the gap size gauge should be employed. This device is placed within the gap and is used to compare the size of the gap compared to a plurality of known measurements. In another embodiment, other means of measuring the gap can be used.

Before removing the gap adjustment wedge, a straight, horizontal line can be drawn across both the latch side and the latch post in order to indicate the desired location for installation of the glides. The wedge can be removed and the gate at least partially opened so that the inner surfaces of both the latch side and latch post can be accessed for installation of the glides. Either glide can be installed on either the latch post or the latch side. Installation involves securing the glides to the latch post and latch side so that the rounded bull-nose of the bull-nose glide impacts the rounded edge of the flat glide as the gate is swung shut. As the two rounded surfaces come together, they slide over one another and cause the gate to be lifted and pushed such that the latch side fits within the gate opening and a constant latch post gap is produced. As the gate comes to rest in the appropriate position, the two glides are resting against one another. If the latch post gap that was previously measured is larger than the width of the two glides then one or more spacers can be placed between the glide(s) and the latch post/latch side during installation, as necessary.

If the present invention is installed on a new gate or on a gate that has not yet begun to suffer from gate sag, the contact between the two glides will be minimal during the gate closing procedure. However, once closed, the glides will be in contact in order to take the stresses off of the hinges and the gate itself and thereby keep gate sag from developing. Therefore, a goal of the present invention is to forestall the development of gate sag in new or otherwise solid gates. Another goal of the present invention is to allow gates that have already begun to succumb to gate sag to be more easily closed and to forestall further deterioration.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a top plan view of an exemplary embodiment of a gate adjustment system;

FIG. 2 illustrates a side elevation view of an exemplary embodiment of a gate adjustment system;

FIG. 3 illustrates a top plan view of an exemplary embodiment of a gate adjustment system installed on a gate;

FIG. 4 illustrates a side perspective view of another embodiment of a gate adjustment system utilizing only a bull-nose glide and a flat glide;

FIG. 5 illustrates a top plan view of an exemplary embodiment of a bull-nose glide, a side elevation view of an exemplary embodiment of a flat glide, and an end elevation view of an exemplary embodiment of a second flat glide;

FIG. 6 illustrates a top plan view and two side elevation views of another embodiment of a bull-nose glide, and a top plan view and a side elevation view of another embodiment of a flat glide;

FIG. 7 illustrates an exemplary embodiment of the gap adjustment wedge and gap size gauge in use; and

FIG. 8, to install the system on gates that swing both in and out, the curved, bull-nose portion 812 of the bull-nose glide 810 should be approximately duplicated as a second curved, bull-nose portion 813 on the other end of the bull-nose glide 810; the curved portion 822 of the flat glide 820 should also be duplicated as a second curved portion 823 on the other end of the flat glide 820.

### DETAILED DESCRIPTION

Referring now to the drawings, exemplary embodiments of the invention are described below in the accompanying Figures. The following detailed description provides a comprehensive review of the drawings in order to provide a thorough understanding of, and an enabling description for, these embodiments. One having ordinary skill in the art will understand that the invention may be practiced without certain details. In other instances, well-known structures and functions have not been shown or described in detail to avoid unnecessarily obscuring the description of the embodiments.

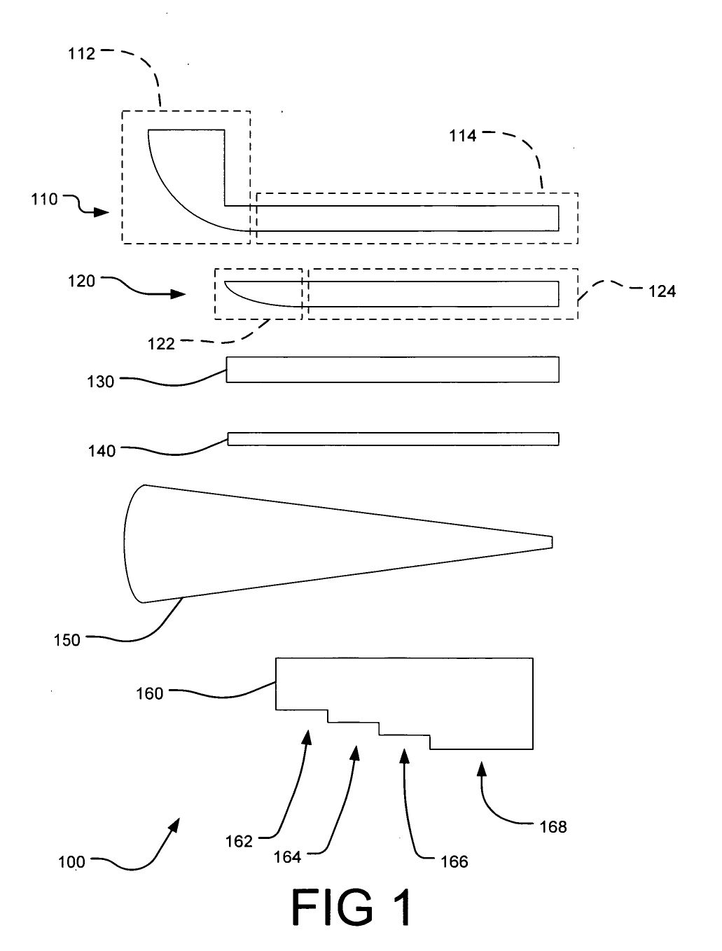

FIG. 1 shows a top plan view of an exemplary embodiment of a gate adjustment system 100. The components shown in FIG. 1 include a bull-nose glide 110, a flat glide 120, a plurality of spacers 130 and 140, a gap adjustment wedge 150, and a gap size gauge 160.

The bull-nose glide 110 has a curved, bull-nose portion 112 and a first mounting block portion 114. The broken-line rectangle labeled “112” surrounds and defines the curved, bull-nose portion 112. The curved, bull-nose portion 112 is shaped so as to distribute the impact forces when the gate is closed and redirect those forces into lifting and pushing the gate back into alignment rather than just having the latch side of the gate impact, and likely bounce off of, the latch post.

The approximately ninety degree angled portion of the bull-nose portion 112 is designed to wrap around the inside and back face of the latch side of a gate. Alternatively, the angled portion can be wrapped around the inside and front face of the latch post. In either case, the majority of the bull-nose portion 112 resides outside of the gate gap (i.e., the space between the latch side of the gate and the upright latch post) when the gate is closed.

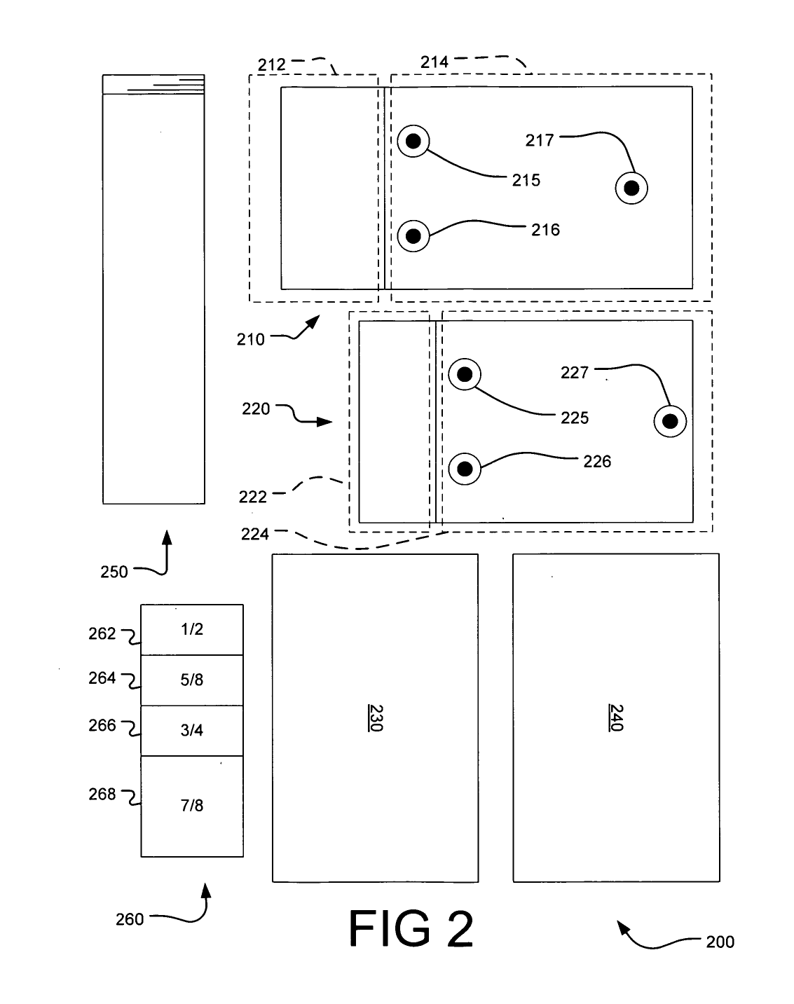

The broken-line rectangle labeled “114” surrounds and defines the first mounting block portion 114 of the bull-nose glide 110. The first mounting block portion 114 is placed against either the inside of the latch post or the inside of the latch side and affixed thereto. When the gate is closed, the first mounting block portion 114 resides within the gate gap. Exemplary placement of the bull-nose glide 110 on a gate assembly can be seen in FIG. 2.

Operating in concert with the bull-nose glide 110 is the flat glide 120. The flat glide 120 has a curved portion 122 and a second mounting block portion 124. The broken-line rectangle labeled “122” surrounds and defines the curved, portion 122. The curved portion 122 is shaped so as to distribute the impact forces when the gate is closed and redirect those forces into lifting and pushing the gate back into alignment rather than just having the latch side of the gate impact, and likely bounce off of, the latch post.

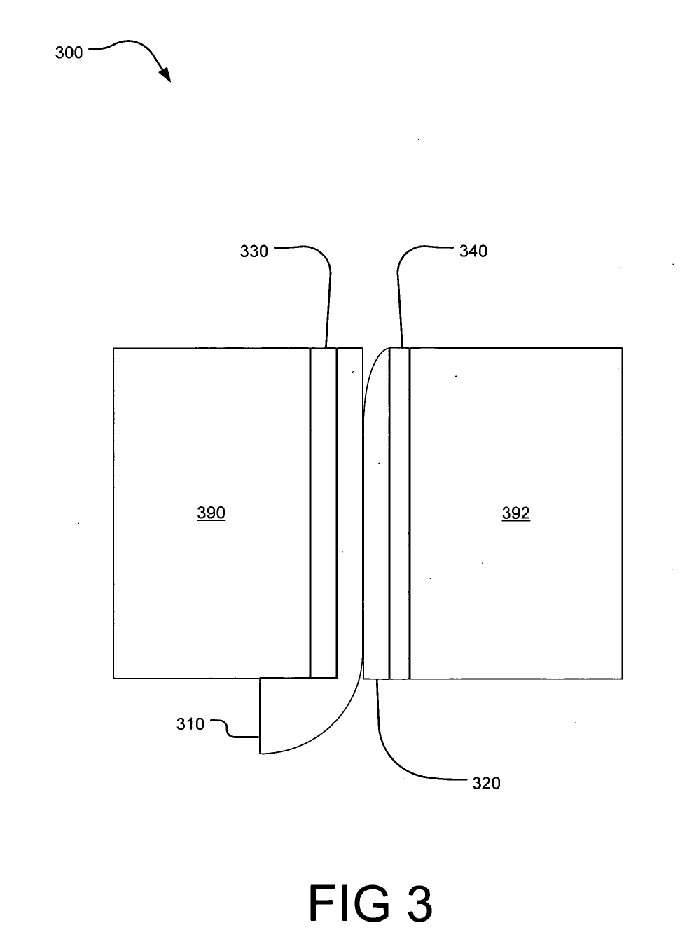

The broken-line rectangle labeled “124” surrounds and defines the second mounting block portion 124 of the flat glide 120. The second mounting block portion 124 is placed against either the inside of the latch post or the inside of the latch side and affixed thereto. Exemplary placement of the flat glide 120 on a gate assembly can be seen in FIG. 3.

Also shown in FIG. 1 are a plurality of spacers 130 and 140. The spacers 130 and 140 can be placed between one or both glides as they are mounted on the latch post and latch side of the gate. FIG. 1 shows two spacers, in other embodiments the number of spacers can be one, two, three, or more.

A gap adjustment wedge 150 is illustrated in FIG. 1. The gap adjustment wedge 150 can be used in combination with the gap size gauge 160. As discussed above, when installing the gate adjustment system, one step is to pull the gate up and into proper alignment. This process is assisted by inserting the gap adjustment wedge 150 between the latch post and the latch side. It is preferable to place the wedge 150 between the top portions of the latch post and the latch side. The wedge 150 should be pushed downwards into the latch post gap (i.e., the space between the latch side of the gate and the latch post) until the gap is the same width down the entire length of the latch side. Once the gap has a uniform width, the gap size gauge 160 can be inserted into the gap. The gap size gauge 160 has a number of differing thicknesses that allow the user to measure the size of the gap using the gauge 160.

In the embodiment shown in FIG. 1, the gap size gauge 160 has four distinct thicknesses: one-half inch, five-eighths inch, three-quarters inch, and seven-eighths inch. In other embodiments, the number of thicknesses can be 1, 2, 3, or more and they can vary in dimension from the exemplary measurements given above. In yet another embodiment, the gap size gauge 160 is continuously varying in thickness, thereby having a virtually unlimited number of thicknesses. The gap size gauge 160 can be placed within the latch post gap and the size of the gap can be thereby determined. For example, if the first thickness 162 of the gap size gauge 160 just fits within the gap, then the gap is approximately one-half inch wide; if the second thickness 164 fits within the gap, then the gap is approximately five-eighths inch wide; etc. It is contemplated that the gap size gauge can include indicia that specify the various gap size measurements.

As illustrated in the embodiment in FIG. 1, the plurality of spacers 130 and 140 are represented by two rectangular, three-dimensional boxes of differing thicknesses. For example, the first spacer 130 can have a thickness of approximately one-eighth inch and the second spacer 140 can have a thickness of approximately one-quarter inch. In one embodiment, the thicknesses of the first mounting block portion 114 of the bull-nose glide 110 and the second mounting block portion 124 of the flat glide 120 are both one-quarter inch (in other embodiments, other thicknesses are contemplated). Thus, the combined thickness of the two mounting blocks 114 and 124 is one-half inch. When the blocks 114 and 124 are properly mounted to the inside of latch post and the latch side so that they abut each other, they have a combined thickness of one-half inch, which allows them to fit within the preferred latch post gap of one-half inch. However, as discussed above, the gap may be larger than one-half inch, as measured using the gap size gauge 160. If the gap is five-eighths inch then the first spacer 130 can be used when mounting either the bull-nose glide or the flat glide. If the gap is three-quarters inch, then the second spacer 140 can be used. If the gap is seven-eighths inch then both spacers 130 and 140 can be employed. As discussed above, other embodiments having a different number of spacers with varying thicknesses are contemplated.

FIG. 2 illustrates a side elevation view of an exemplary embodiment of a gate adjustment system 200. The components shown in FIG. 2 include a bull-nose glide 210, a flat glide 220, a plurality of spacers 230 and 240, a gap adjustment wedge 250, and a gap size gauge 260. The illustrated components in FIG. 2 are the same as those shown in FIG. 1, except that the view is a side elevation view and some of the components have been rotated one hundred and eighty degrees to better fit the available space.

The bull-nose glide 210 has a curved, bull-nose portion 212 and a first mounting block portion 214. The broken-line rectangle labeled “212” surrounds and defines the curved, bull-nose portion 212. The curved, bull-nose portion 212 is shaped so as to distribute the impact forces when the gate is closed and redirect those forces into lifting and pushing the gate back into alignment rather than just having the latch side of the gate impact, and likely bounce off of, the latch post.

The broken-line rectangle labeled “214” surrounds and defines the first mounting block portion 214 of the bull-nose glide 210. The first mounting block portion 214 is placed against either the inside of the latch post or the inside of the latch side of the gate and affixed thereto. Exemplary placement of the bull-nose glide 210 on a gate assembly can be seen in FIG. 3. Also illustrated in FIG. 2 is an exemplary means of mounting the bull-nose glide 210: holes for mounting screws are depicted and labeled 215, 216, and 217. In other embodiments, other numbers and locations of mounting holes are contemplated as are other mounting means besides holes and screws.

Operating in concert with the bull-nose glide 210 is the flat glide 220. The flat glide 220 has a curved portion 222 and a second mounting block portion 224. The broken-line rectangle labeled “222” surrounds and defines the curved, portion 222. The curved portion 222 is shaped so as to distribute the impact forces when the gate is closed and redirect those forces into lifting and pushing the gate back into alignment rather than just having the latch side of the gate impact, and likely bounce off of, the latch post.

The broken-line rectangle labeled “224” surrounds and defines the second mounting block portion 224 of the flat glide 220. The second mounting block portion 224 is placed against either the inside of the latch post or the inside of the latch side and affixed thereto. Exemplary placement of the flat glide 220 on a gate assembly can be seen in FIG. 3. Also illustrated in FIG. 2 is an exemplary means of mounting the flat glide 220: holes for mounting screws are depicted and labeled 225, 226, and 227. In other embodiments, other numbers and locations of mounting holes are contemplated as are other mounting means besides holes and screws. For example, mounting options can include adhesives, nails, bolts, etc.

A plurality of spacers 230 and 240 are illustrated in the embodiment shown in FIG. 2. The spacers 230 and 240 can be placed between one or both glides as they are mounted on the latch post and latch side of the gate. FIG. 2 shows two spacers, in other embodiments the number of spacers can be one, two, three, or more. The spacers serve to fill in excess space for installations in which the gap size (between the latch side of the gate and the latch post) is overly large.

A gap adjustment wedge 250 is illustrated in FIG. 2. The gap adjustment wedge 250 can be used in combination with the gap size gauge 260. As discussed above, when installing the gate adjustment system, one step is to pull the gate up and into proper alignment. This process is assisted by inserting the gap adjustment wedge 250 between the latch post and the latch side. It is preferable to place the wedge 250 between the top portions of the latch post and the latch side. The wedge 250 should be pushed downwards into the latch post gap until the gap is the same width down the entire length of the latch side. Once the gap is uniform, the gap size gauge 260 can be inserted into the gap. The gap size gauge 260 has a number of differing thicknesses that allow the user to measure the size of the gap using the gauge 260.

In the embodiment shown in FIG. 2, the gap size gauge 260 has four distinct thicknesses: one-half inch, five-eighths inch, three-quarters inch, and seven-eighths inch. In other embodiments, the number of thicknesses can be 1, 2, 3, or more and they can vary in dimension from the exemplary measurements given above. In yet another embodiment, the gap size gauge 260 is continuously varying in thickness, thereby having a virtually unlimited number of thicknesses. The gap size gauge 260 can be placed within the latch post gap and the size of the gap can be thereby determined. For example, if the first thickness 262 of the gap size gauge 260 just fits within the gap, then the gap is approximately one-half inch wide; if the second thickness 264 fits within the gap, then the gap is approximately five-eighths inch wide; etc. In one embodiment, the gap size gauge 260 incorporates a number of measurement indicia in order to enhance the user's ability to quickly determine the appropriate gap size—see indicia in FIG. 2, including: ½, ⅝, ¾, and ⅞.

As illustrated in the embodiment in FIG. 2, the plurality of spacers 230 and 240 are represented by two rectangular, three-dimensional boxes of differing thicknesses (see top plan view in FIG. 1 to clearly see the varying thicknesses). For example, the first spacer 230 can have a thickness of one-eighth inch and the second spacer 240 can have a thickness of one-quarter inch. In one embodiment, the thicknesses of the first mounting block portion 214 of the bull-nose glide 210 and the second mounting block portion 224 of the flat glide 220 are both one-quarter inch. Thus, the combined thickness of the two mounting blocks 214 and 224 is one-half inch. When the blocks 214 and 224 are properly mounted to the inside of latch post and the latch side so that they abut each other, they have a combined thickness of one-half inch, which allows them to fit within the preferred latch post gap of one-half inch. However, as discussed above, the gap may be larger than one-half inch, as measured using the gap size gauge 260. If the gap is five-eighths inch then the first spacer 230 can be used when mounting either the bull-nose glide or the flat glide. If the gap is three-quarters inch, then the second spacer 240 can be used. If the gap is seven-eighths inch then both spacers 230 and 240 can be employed. As discussed above, other embodiments having a different number of spacers with varying thicknesses are contemplated. Furthermore, the plurality of spacers 230 and 240 could have identifying width indicia on them in order to help the user identify which spacers to use based on the measured gap size.

In some installations, it is contemplated that the gap size may be less than one half inch. If this is the case, the posts, gate and/or hinges may need to be adjusted in order to increase the gap to one half inch or more. Alternatively, either or both of the latch side of the gate or the latch post can have material removed therefrom in order to accommodate the system components therebetween.

FIG. 3 illustrates a top plan view of an exemplary embodiment of a gate adjustment system 300 installed on a gate. The gate components depicted are the latch post 390 and the latch side 392. In the exemplary embodiment of FIG. 3, the bull-nose glide 310 is installed with a thicker first spacer 330 against the latch post 390. The flat glide 320 is installed with a second spacer 340 against the latch side 392. The gate is shown in a closed position. In other embodiments, the glides 310 and 320 can be installed with fewer (e.g., zero or one) or three or more spacers.

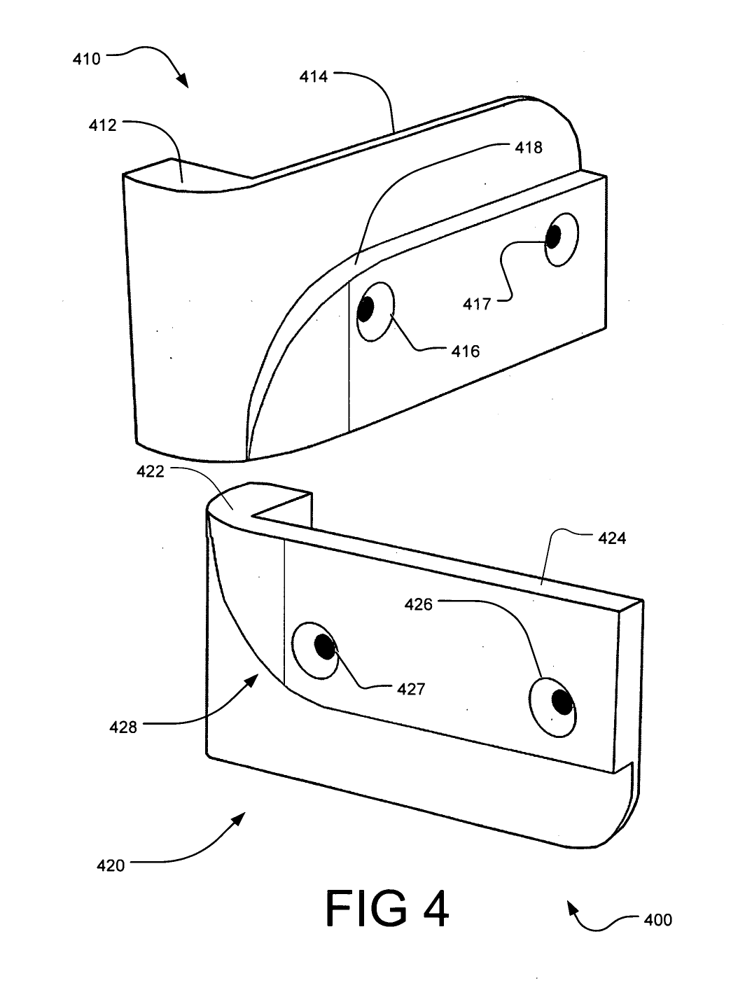

It is to be understood that the system can be embodied in various sizes having various dimensions besides those shown in the accompanying figures. For example, the system could be built for 2×4 gates, 4×4 gates, 2×6 gates, smaller gates, larger gates, etc. Furthermore, although FIG. 3 depicts installation of the system components so that they are abutting, the system can be installed with a certain amount of play between one or more of the components (for example, between the two glides). For example, the embodiment described in FIG. 4 below, can be installed such that the compound curves of the two glides abut when the gate is closed, but the curved, bull-nose portion of each glide may not impact the opposite glide when the gate is closed. This serves to keep the gate from experiencing gate sag, while also allowing the gate to be closed and opened with minimal force.

Installation of the system can be performed on older gates that have already experienced gate sag, those that may yet experience gate sage, new gates, etc. The system can be incorporated into new gate materials so that it is built into a gate as the gate is constructed or it can be added at a later time. The gate adjustment system components can be made out of a variety of materials and are not limited to any specific materials or group of materials. Possible examples of materials include, but are not limited to: injection molded plastic, high impact materials, impact resistant materials, low friction materials, outdoor application long-life materials (e.g., ozone resistant, high/low temperature-variation resistant, water resistant, UV resistant, etc.), materials having combinations of features, etc.

FIG. 4 illustrates a side perspective view of another embodiment of a gate adjustment system 400, utilizing only a bull-nose glide 410 and a flat glide. 420. In the embodiment shown in FIG. 4, the flat glide 420 has a similar shape, size, and appearance as the bull-nose glide 410. The bull-nose glide 410 has a curved, bull-nose portion 412 and a first mounting block portion 414. The curved, bull-nose portion 412 is shaped so as to distribute the impact forces when the gate is closed and redirect those forces into lifting and pushing the gate back into alignment rather than just having the latch side of the gate impact, and likely bounce off of, the latch post. The first mounting block portion 414 allows the bull-nose glide 410 to be securely mounted onto either the inside of a latch post or the inside of the latch side of a gate.

In the embodiment illustrated in FIG. 4, the flat glide 420 also has a curved, bull-nose portion 422 and a second mounting block portion 424. The curved, bull-nose portion 422 is shaped so as to distribute the impact forces when the gate is closed and redirect those forces into lifting and pushing the gate back into alignment rather than just having the latch side of the gate impact, and likely bounce off of, the latch post. The second mounting block portion 424 allows the flat glide 420 to be securely mounted onto either a latch post or a latch side of the gate.

Both glides 410 and 420 have mounting holes, shown in FIG. 4 as screw holes 416 and 417 for the bull-nose glide 410 and screw holes 426 and 427 for the flat glide 420. In other embodiments, other means of securing the glides to the mounting locations are contemplated. Furthermore, the numbers and locations of mounting holes may differ from those depicted in FIG. 4.

Also illustrated in FIG. 4 are compound curves that can be added to the glides 410 and 420. The first compound curve 418 is depicted on the bull-nose glide 410 and the second compound curve 428 is depicted on the flat glide 420. As can be understood by the shapes of the various curves depicted in FIG. 4, when properly mounted on the latch post and the latch side, the two glides 410 and 420 will impact each other when the gate is closed. First, the bull-nose portions 412 and 422 impact one another, and they serve to force the gate backwards towards the hinge side and into the correct position. Then, as the gate continues to close, the first and second compound curves 418 and 428 impact each other, causing the flat glide 420 to be lifted and forcing the gate upwards and into the correct position as the second compound curve 428 rides on top of the first compound curve 418 and the gate is fully closed.

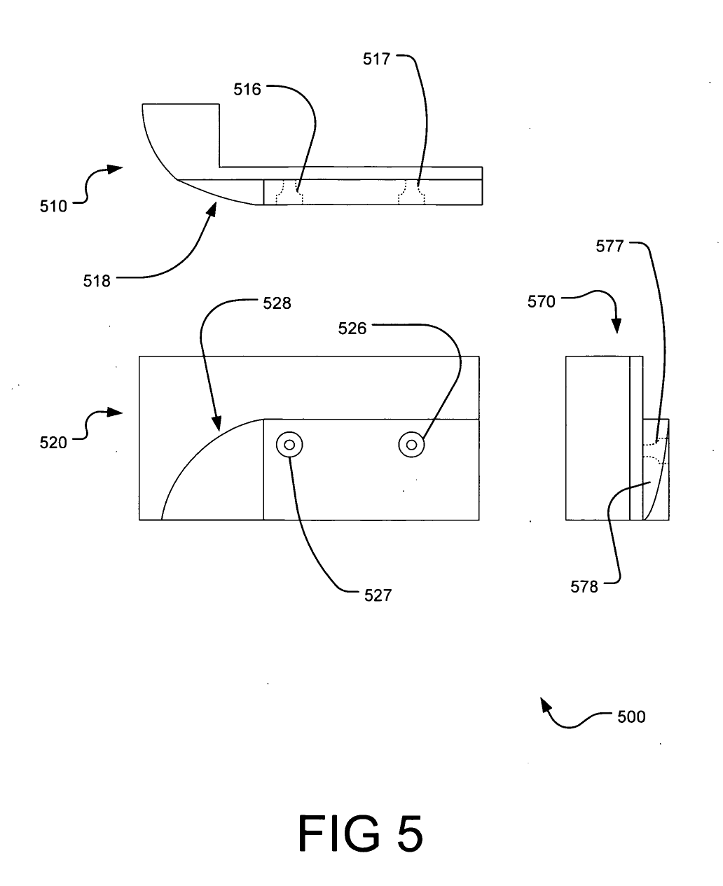

FIG. 5 illustrates various views of components of another exemplary embodiment of a gate adjustment system 500. The components shown in FIG. 5 include a top plan view of an exemplary embodiment of a bull-nose glide 510, a side elevation view of an exemplary embodiment of a flat glide 520, and an end elevation view of a second exemplary embodiment of a flat glide 570. The relative dimensions shown in FIG. 5 are for illustrative purposes only and show only potential embodiments—other embodiments having varying dimensions are within the scope of the invention. The compound curve elements of the embodiment shown in FIG. 4 are also depicted in FIG. 5.

The bull-nose glide 510 has a first compound curve 518 and the flat glide 520 has a second compound curve 528. Both glides 510 and 520 have mounting holes, shown in FIG. 5 as screw holes 516 and 517 for the bull-nose glide 510 and screw holes 526 and 527 for the flat glide 520. The end elevation view of the second flat glide 570 also shows a third compound curve 578 and a screw hole 577.

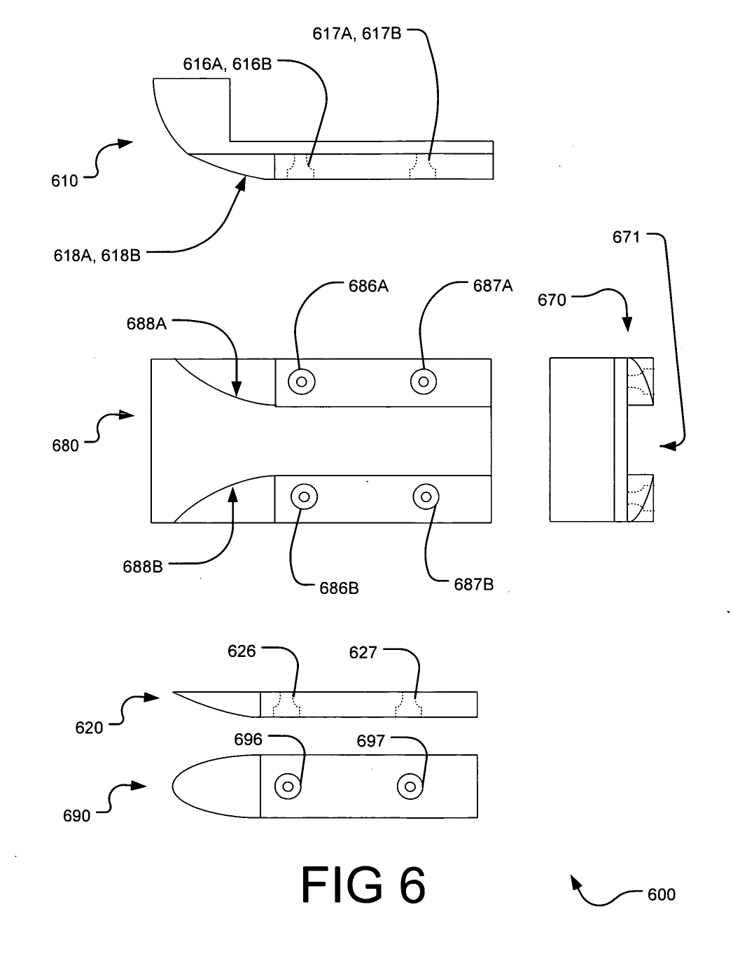

FIG. 6 illustrates various views of components of another exemplary embodiment of a gate adjustment system 600. The components illustrated in FIG. 6 include a top plan view of an exemplary embodiment of a bull-nose glide 610, a side elevation view of an exemplary embodiment of a second bull-nose glide 680, an end elevation view of an exemplary embodiment of a third bull-nose glide 670, a top plan view of an exemplary embodiment of a flat glide 620, and a side elevation view of an exemplary embodiment of a second flat glide 690.

The embodiment of the bull-nose glide 610 in FIG. 6 has a similar bull-nose feature as the other embodiments, but has two compound curve features 618A and 618 B—one above the other. They serve to corral the flat glide 620 (or 690) between them and thus force the gate into the correct position. Furthermore, the position of the two compound curve features 618A and 618B allow the bull-nose glide 610 to be used on either face of the latch side of a gate to accommodate both lefthand and righthand gates as well as gates that swing outwards or inwards. To accommodate these various installation options, the bull-nose glide 610 would simply need to be flipped over. However, if the bull-nose glide 610 only had a single compound curve feature then two bull-nose glides (one a mirror image of the other) would be required to accommodate installation of the gate adjustment system for each of the various gate designs.

The flat glide 620 has a curved portion similar to that shown in FIG. 1, however, it has two compound curve edges that work in concert with the compound curves in the bull-nose glide 610 to lift the gate up or push it down and ensure it is in the correct position as the gate is swung closed. When the glides 610 and 620 are properly mounted on a gate latch side and latch post and the gate is closed, the flat glide 620 will be surrounded on three sides by the bull-nose glide 610. The relative dimensions shown in FIG. 6 are for illustrative purposes only and show only potential embodiments—other embodiments having varying dimensions are within the scope of the invention. As with the bull-nose glide 610, the two compound curve edges of the flat glide 620 allow a single flat glide 620 to be used in installations of the system for all gate types discussed above.

The first bull-nose glide 610 has four screw holes 616A, 616B, 617A, and 617B. The second bull-nose glide 680 also is shown with four screw holes 686A, 686B, 687A, and 687B. Either or both glides 610, 620 can have more or fewer screw holes in other embodiments. Similarly, the third bull-nose glide 670 is shown with two screw holes, but other numbers and locations of holes are contemplated. The third bull-nose glide is shown from an end elevation view so it is easy to see the slot 671 in which the flat glide 620/690 can slide into.

The embodiment of the second bull-nose glide 680 in FIG. 6 has a similar bull-nose feature as the other embodiments, but has two compound curve features 688A and 688B—one above the other. They serve to corral the flat glide 620/690 between them and thus force the gate into the correct position. The flat glide 620/690 has a curved portion similar to that shown in FIG. 1; however, it has two compound curve edges that work in concert with the compound curves 688A and 688B in the bull-nose glide 680 to lift the gate up or push it down and ensure it is in the correct position as the gate is swung closed. When the glides 680 and 620/690 are properly mounted on a gate latch side and latch post and the gate is closed, the flat glide 620/690 will be surrounded on three sides by the bull-nose glide 680. The relative dimensions shown in FIG. 6 are for illustrative purposes only and show only potential embodiments—other embodiments having varying dimensions are within the scope of the invention.

The first flat glide 620 is illustrated with screw holes 626 and 627 and the second flat glide 690 is illustrated with screw holes 696 and 697. Other numbers and locations of screw holes are contemplated in other embodiments.

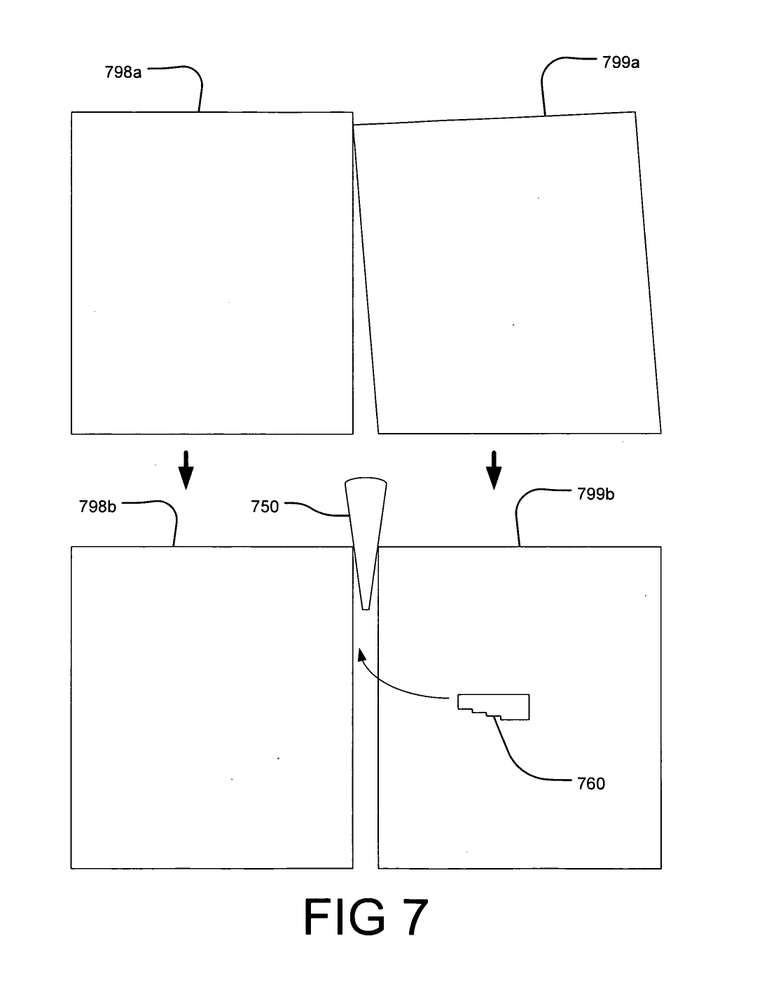

FIG. 7 illustrates usage of the gap adjustment wedge 750 and gap size gauge 760. The top of FIG. 7 shows an exemplary embodiment of a latch post 798a and a latch side 799a wherein the gate has sagged and the latch side 799a is improperly impacting the latch post 798a. Moving to the bottom of FIG. 7, the gap adjustment wedge 750 has been placed between the latch post 798b and the latch side 799b and forced the latch side 799b back into correct alignment creating a uniform gap between the latch side 799b and the latch post 798b. The gap size gauge 760 can then be inserted in the gap and used to measure the gap. That measurement then determines how many (if any) spacers will be needed during installation of the bull-nose glide and flat glide.

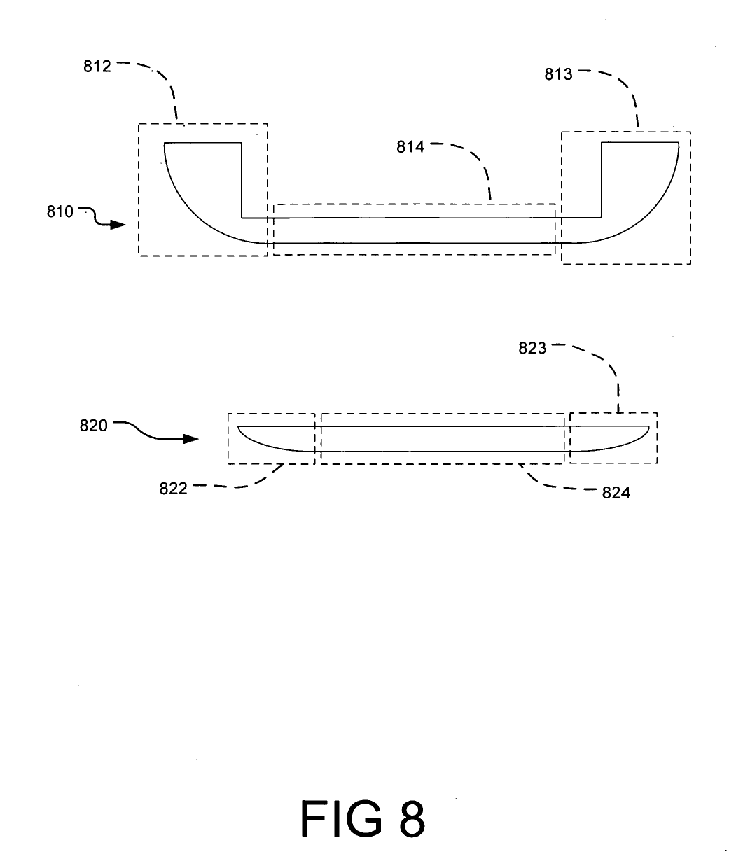

As can be understood from the illustrations in the Figures, in one embodiment of the system, the components can be designed such that they can be used on gates that are right-hand gates or those that are termed left-hand gates, as well as gates that swing in or out (or both). As depicted in FIG. 8, to install the system on gates that swing both in and out, the curved, bull-nose portion 812 of the bull-nose glide 810 should be approximately duplicated as a second curved, bull-nose portion 813 on the other end of the bull-nose glide 810; the curved portion 822 of the flat glide 820 should also be duplicated as a second curved portion 823 on the other end of the flat glide 820. It should be understood that other embodiments (including those depicted in FIGS. 1-7) can be modified in a manner similar to that in FIG. 8 such that they can be used on gates that swing both in and out. The first and second mounting block portions 814 and 824 can be stretched or shrunk in length to accommodate gates and gate latch posts of various sizes.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. A gate adjustment system for a gate, wherein the gate has a latch side and a hinge side and is designed to be closed within a space defined by a latch post and a hinge post, the system comprising:
a bull-nose glide having a curved, bull-nose portion and a first mounting block portion, and wherein the bull-nose portion attaches to the first mounting block portion forming a back side having a wrap-around angle;
a flat glide having a curved portion and a second mounting block portion; and
wherein the bull-nose glide and the flat glide are mounted opposite each other on the latch post and latch side such that when the gate is swung shut, the curved, bull-nose portion of the bull-nose glide first contacts and then slides against the curved portion of the flat glide thereby causing the gate to be forced into proper alignment with the latch post and the hinge post as the gate is closed.

2. The gate adjustment system of claim 1, further comprising: a plurality of spacers configured to be placed between the bull-nose glide and the latch post.

3. The gate adjustment system of claim 1, further comprising: a plurality of spacers configured to be placed between the flat glide and the latch side.

4. The gate adjustment system of claim 1, further comprising: a gap adjustment wedge having a gradually increasing thickness such that it can be placed between the latch post and the latch side and forced downwards in order to separate the latch side from the latch post.

5. The gate adjustment system of claim 1, further comprising: a gap size gauge having a plurality of measurements and shaped so as to fit within a gap between the latch post and the latch side of the gate.

6. The gate adjustment system of claim 1, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

7. The gate adjustment system of claim 2, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

8. The gate adjustment system of claim 3, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

9. The gate adjustment system of claim 1, further comprising: a plurality of spacers configured to be placed between the bull-nose glide and the latch side and a second plurality of spacers configured to be placed between the flat glide and the latch post.

10. The gate adjustment system of claim 9, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

11. A gate adjustment system for a gate, wherein the gate has a latch side and a hinge side and is designed to be closed within a space defined by a latch post and a hinge post, the system comprising:
a bull-nose glide having a curved, bull-nose portion and a first mounting block portion, and wherein the bull-nose portion attaches to the first mounting block portion forming a back side having a wrap-around angle;
the bull-nose glide having a first compound curve portion beginning on the bull-nose portion and extending onto the first mounting block portion;
a flat glide having a curved portion and a second mounting block portion;
the flat glide having a second compound curve portion beginning on the curved portion and extending onto the second mounting block portion;
wherein the bull-nose glide and the flat glide are mounted opposite each other on the latch post and latch side such that when the gate is swung shut, the curved, bull-nose portion of the bull-nose glide approaches and contacts the curved portion of the flat glide; and
wherein the first compound curve portion is designed to accept contact with the second compound curve portion as the gate is shut, the first and second compound curve portions interacting to lift the gate and push it back towards the hinge side and into alignment.

12. The gate adjustment system of claim 11, further comprising: a plurality of spacers configured to be placed between the bull-nose glide and the latch side, and a second plurality of spacers configured to be placed between the flat glide and the latch post.

13. The gate adjustment system of claim 11, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate:

14. The gate adjustment system of claim 11, further comprising: a plurality of spacers configured to be placed between the bull-nose glide and the latch post, and a second plurality of spacers configured to be placed between the flat glide and the latch side.

15. The gate adjustment system of claim 12, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

16. The gate adjustment system of claim 14, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

17. The gate adjustment system of claim 11, further comprising:
the bull-nose glide having a third compound curve portion beginning on the bull-nose portion and extending onto the first mounting block portion and thereby forming a slot between the first compound curve portion and the third compound curve portion;
the flat glide having a fourth compound curve portion beginning on the curved portion and extending onto the second mounting block portion, the second compound curve and fourth compound curve joined such that the flat glide has a half-bullet like shape; and
wherein the flat glide is positioned such that when the gate is closed the flat glide is forced into the slot causing the gate to be forced into alignment.

18. The gate adjustment system of claim 17, further comprising: a plurality of spacers configured to be placed between the bull-nose glide and the latch side, and a second plurality of spacers configured to be placed between the flat glide and the latch post.

19. The gate adjustment system of claim 17, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.

20. The gate adjustment system of claim 18, further comprising: a gap adjustment wedge having a gradually increasing thickness such that it can be placed between the latch post and the latch side and forced downwards in order to separate the latch side from the latch post, and a gap size gauge having a plurality of measurements and shaped so as to fit within a gap between the latch post and the latch side of the gate.
